(19) United States
(12) Patent Application Publication
(10) Pub. No.: US 2013/0191776 A1
(43) Pub. Date: Jul. 25, 2013

(54) METHOD OF ACTIVATING ACTIVATABLE CONTENT ON AN ELECTRONIC DEVICE DISPLAY

(71) Applicants: Christopher Shannon Harris, London (GB); Mateusz Piotr Stawecki, London (GB); Edward Adam Swinden, Surrey (GB)

(72) Inventors: Christopher Shannon Harris, London (GB); Mateusz Piotr Stawecki, London (GB); Edward Adam Swinden, Surrey (GB)

(73) Assignee: THE OTHER MEDIA LIMITED, London (GB)

(21) Appl. No.: 13/434,038

(22) Filed: Mar. 29, 2012

Related U.S. Application Data
(60) Provisional application No. 61/588,747, filed on Jan. 20, 2012.

(51) Int. Cl. G06F 3/048

(52) U.S. Cl. 715/784

(57) ABSTRACT

An electronic device comprising an electronic device display; and a scrolling arrangement. The electronic device is configured to activate activatable content on the electronic device display by: i) a user actuating the scrolling arrangement of the electronic device to scroll substantially continuously through content including activatable content displayed on the electronic device display; ii) the user stopping actuating the scrolling arrangement; and iii) without user actuation of the electronic device, the electronic device activating the activatable content if the activatable content stops scrolling between two spaced apart limits of the electronic device display. The activatable content may be displayed in less than a majority of the electronic device display; and the electronic device display may display the activatable content in a majority of the electronic device display area if the activatable content stops scrolling between two spaced apart limits of the electronic device display.

The present invention relates to a method of activating activatable content, such as, but not limited to, a video or a game, on an electronic device display and an electronic device, in particular, but not limited to, a computer such as a PC, laptop or a tablet computer, such as an Apple iPad, iPad 2 or iPad 3 (the new iPad), or a smartphone, such as an Apple iPhone. Embodiments of the invention relate to a method for activating applications embedded in a scrolling document displayed in an electronic device display by proximity to the center of the window of the display.

### BACKGROUND OF THE INVENTION

Known window based applications for both touch and mouse driven electronic devices often have long scrolling sections of text interspersed with applications or activatable content such as video, slideshows, audio content or even games embedded within the flow of the text. Typically, a user will have to perform multiple actions such as clicking or tapping buttons to begin using the embedded application. This is illustrated in FIG. 1.

FIG. 1 shows a touch-screen display 10 of an electronic device, in this example, an Apple iPad in a portrait configuration. The display shows a webpage including a text portion 12 and a portion of activatable content 14, in this example, a video within the text portion and fixed relative to it. In this case, the video is stopped or paused (the activatable content is inactive) and a single still image or frame from the video is displayed. The image displayed does not change as the webpage is scrolled through. The image displayed fills only a portion of the display. It is a so-called thumbnail.

A user scrolls through the webpage by dragging their finger 16 over the touch screen display 10 and the screen is configured such that the content of the webpage (text and still video frame) follows their finger movement. So, in this case, as the user drags their finger, in the plane of the display, away from the user, the content (text and still video frame) of the display also moves in the plane of the display, away from the user (up the page in the example of FIG. 1).

If the user wishes to play the embedded video or, in other words, activate the activatable content 14 of the webpage, he stops dragging his finger 16 over the display 10 so that movement of the webpage (text 12 and still video frame) stops and it stops so that the video frame is displayed on the display. To start the video playing, the user selects a play button 18 displayed on the display and forming, in this example, part of the still video frame, by pressing the touch screen where the button is displayed. As a result, the video starts playing (the activatable content is active) and the appearance of the play button changes to a pause or stop button (not illustrated). The displayed area of video remains the same size when it plays. The user may enlarge the displayed size of the video to fill the screen by pressing a full screen button 20 displayed on the display, and forming, in this example, part of the video frame. The user may also increase the size of the displayed video by, for example, rotating the device to a landscape configuration, in which case, the video fills the screen.

To stop the video 14 playing, in the portrait configuration, a user presses the stop button.

To stop the video 14 playing, in the enlarged landscape configuration, the user must first rotate the screen or display 10 back round to the portrait configuration and then continue as for the portrait configuration by pressing the stop button as explained above.

Thus, multiple button or screen presses/manipulations are required to stop and start or enlarge embedded video or other activatable content 14. This disrupts the user experience, particularly when a user starts a video, or other embedded media, and might want only to have a quick look to get a flavor for the video before either stopping it, if it is not of interest, or continuing to watch, if it is of interest.

### BRIEF SUMMARY OF THE INVENTION

The method and electronic device of embodiments of the present invention do away with these actions by automatically enlarging and activating the embedded application or activatable content based on proximity to the center of the screen and the velocity of the scroll speed. Embodiments of the invention provide a better, smoother, user experience for users scrolling through and experiencing content including text and activatable content.

The invention in its various aspects is defined in the independent claims below to which reference should now be made. Advantageous features are set forth in the dependent claims.

In an aspect of the present invention, there is provided a method of activating activatable content on an electronic device display, the method comprising the steps of: i) a user actuating a scrolling arrangement of an electronic device to scroll substantially continuously through content including activatable content displayed on the electronic device display; ii) the user stopping actuating the scrolling arrangement; and iii) without user actuation of the electronic device, the electronic device activating the activatable content if the activatable content stops scrolling between two spaced apart limits of the electronic device display.

This method provides a good, smooth user experience for accessing or activating activatable content, such as video, embedded in electronic content such as a webpage.

Step i) may further comprise the step of providing an indication of the activatable content when it is between the limits. The indication may comprise a visual cue. The visual cue may comprise an increase in size of the activatable content. The indication may be greater the closer the activatable content is to a line centered between the limits.

By providing this type of indication, it is clear to a user that content is automatically activatable and that it may be automatically activated by stopping scrolling.

Step iii) may further comprise the step of providing an indication of the activatable content when it is between the limits. The indication may comprise a visual cue. The visual cue may comprise a darkening of content except all activatable content at least a part of which is between the limits. The darkening may comprise the content, except all activatable content at least a part of which is between the limits, not being displayed.

By providing this type of indication, it is clear that content has been automatically activated and, particularly when the content except activatable content is darkened, the automatically activated content is clear to view.

Step iii) may further comprise centering the activatable content on a line centered between the limits.

This makes the activatable content easier to view.

Step i) may comprise activatable content displayed in less than a majority of the electronic device display; and step iii) may further comprise the electronic device display displaying the activatable content in a majority of the electronic device display area.

This makes the activatable content conveniently, easier to view.

The method may further comprise the step of: iv) a user actuating a scrolling arrangement of an electronic device in the same direction or axis as step i) causing the activatable content to stop activating.

This is an intuitive and convenient way to stop the activatable content.

The method may further comprise the step of: iv) a user actuating a scrolling arrangement of an electronic device in the same direction or axis as step i) causing the activatable content to stop activating; and v) displaying the activatable content the same size as in step i). The same direction may comprise a downward direction of the electronic device display.

This is an intuitive and convenient way to stop the activatable content.

In another aspect of the present invention, there is provided a method of displaying content on an electronic device display, the method comprising the steps of: i) a user actuating a scrolling arrangement of an electronic device to scroll substantially continuously through content, including activatable content displayed in less than a majority of the electronic device display, displayed on the electronic device display; ii) the user stopping actuating the scrolling arrangement; and iii) the electronic device display displaying the activatable content in a majority of the electronic device display area if the activatable content stops scrolling between two spaced apart limits of the electronic device display.

This makes activatable content stand-out conveniently to a user.

Step i) may further comprise the step of providing an indication of the activatable content when it is between the limits. The indication may comprise a visual cue. The visual cue comprises an increase in size of the activatable content. The indication may be greater the closer the activatable content is to a line centered between the limits.

Step iii) may further comprise the step of providing an indication of the activatable content when it is between the limits. The indication may comprise a visual cue. The visual cue may comprise a darkening of content except all activatable content at least a part of which is between the limits. The darkening may comprise the content, except all activatable content at least a part of which is between the limits, not being displayed.

Step iii) may further comprise centering the activatable content on a line centered between the limits.

The method may further comprise the step of: iv) a user actuating a scrolling arrangement of an electronic device in the same direction or axis as step i) causing the activatable content to stop activating.

The method may further comprise the step of: iv) a user actuating a scrolling arrangement of an electronic device in the same direction or axis as step i) causing the activatable content to stop activating; and v) displaying the activatable content the same size as in step i).

The same direction may comprise a downward direction of the electronic device display.

In a further aspect of the present invention, there is provided an electronic device comprising: an electronic device display; and a scrolling arrangement; the electronic device being configured to activate activatable content on the electronic device display by: i) a user actuating the scrolling arrangement of the electronic device to scroll substantially continuously through content including activatable content displayed on the electronic device display; ii) the user stopping actuating the scrolling arrangement; and iii) without user actuation of the electronic device, the electronic device activating the activatable content if the activatable content stops scrolling between two spaced apart limits of the electronic device display.

i) may further comprise providing an indication of the activatable content when it is between the limits. The indication may comprise a visual cue. The visual cue may comprise an increase in size of the activatable content. The indication may be greater the closer the activatable content is to a line centered between the limits.

iii) may further comprise providing an indication of the activatable content when it is between the limits. The indication may comprise a visual cue. The visual cue may comprise a darkening of content except all activatable content at least a part of which is between the limits. The darkening may comprise the content, except all activatable content at least a part of which is between the limits, not being displayed.

iii) may further comprise centering the activatable content on a line centered between the limits.

i) may comprise activatable content being displayed in less than a majority of the electronic device display; and iii) may further comprise the electronic device display displaying the activatable content in a majority of the electronic device display area.

The electronic device may be further configured such that: iv) a user actuating the scrolling arrangement of the electronic device in the same direction or axis as i) causes the activatable content to stop activating.

The electronic device may be further configured such that: iv) a user actuating the scrolling arrangement of the electronic device in the same direction or axis as i) causes the activatable content to stop activating; and v) displaying the activatable content the same size as in i).

The same direction may comprise a downward direction of the electronic device display.

In a further aspect of the present invention, there is provided an electronic device comprising: an electronic device display; and a scrolling arrangement; the electronic device being configured to display content on the electronic device display by: i) a user actuating the scrolling arrangement of the electronic device to scroll substantially continuously through content, including activatable content displayed in less than a majority of the electronic device display, displayed on the electronic device display; ii) the user stopping actuating the scrolling arrangement; and iii) the electronic device display displaying the activatable content in a majority of the electronic device display area if the activatable content stops scrolling between two spaced apart limits of the electronic device display.

i) may further comprise providing an indication of the activatable content when it is between the limits.

The indication may comprise a visual cue. The visual cue may comprise an increase in size of the activatable content. The indication may be greater the closer the activatable content is to a line centered between the limits.

iii) may further comprise providing an indication of the activatable content when it is between the limits. The indication may comprise a visual cue. The visual cue may comprise a darkening of content except all activatable content at least a part of which is between the limits. The darkening may comprise the content, except all activatable content at least a part of which is between the limits, not being displayed.

iii) may further comprise centering the activatable content on a line centered between the limits.

The electronic device may be further configured such that: iv) a user actuating the scrolling arrangement of the electronic device in the same direction or axis as step i) causes the activatable content to stop activating.

The electronic device may be further configured such that: iv) a user actuating the scrolling arrangement of the electronic device in the same direction or axis as i) causes the activatable content to stop activating; and v) displaying the activatable content the same size as in i).

The same direction may comprise a downward direction of the electronic device display.

### BRIEF DESCRIPTION OF THE DRAWINGS

The invention will be described in more detail, by way of example, with reference to the accompanying drawings, in which:

FIG. 1 (prior art) is a view of a display of a known electronic device (in this example, an Apple iPad);

FIG. 2 is a schematic of the electronic device (in this example, an Apple iPad), embodying an aspect of the present invention;

FIG. 3 is a flow diagram illustrating an embodiment of the present invention; and

FIGS. 4 to 12 are each a view of a display of an electronic device embodying an aspect of the present invention.

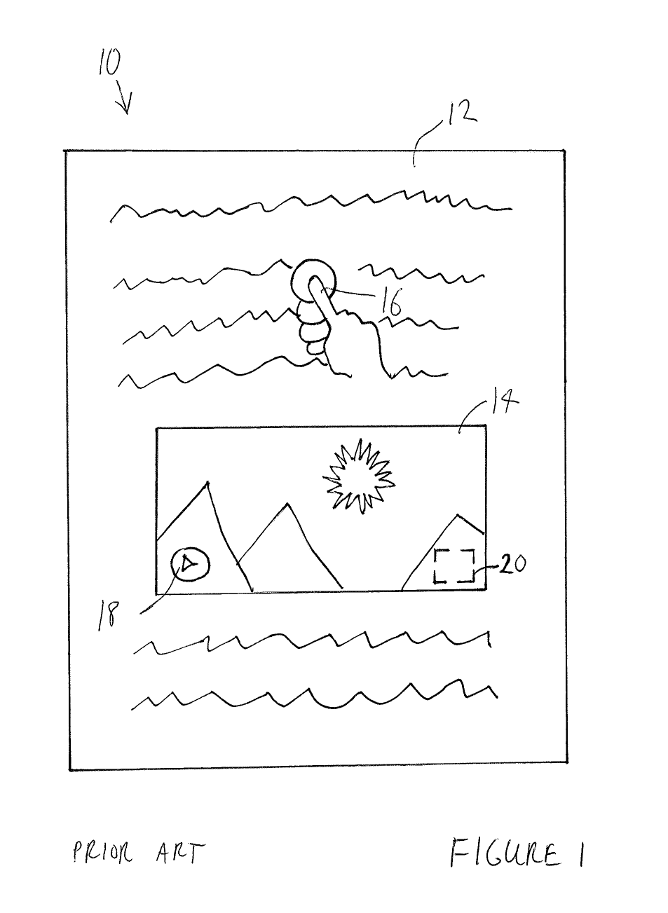

### DETAILED DESCRIPTION OF THE INVENTION

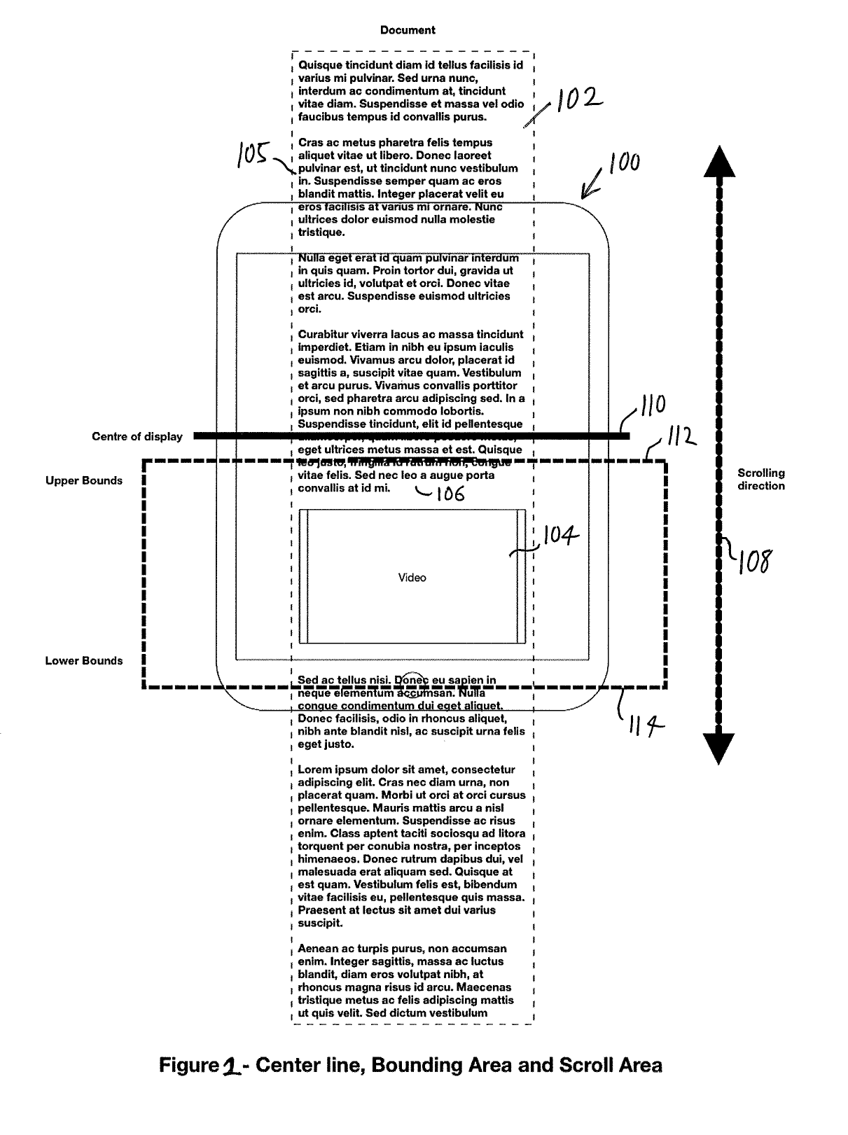

An example electronic device 100 and method embodying aspects of the present invention will now be described with reference to FIGS. 2 to 12. In this example, the electronic device is a computer and in particular a tablet computer in the form of an Apple iPad, iPad 2 or iPad 3 (the new iPad). However, embodiments of the invention may be implemented by other electronic devices or computers, in particular, but not limited to, a PC (personal computer or desktop computer), a laptop or laptop computer, or a smartphone, such as an Apple iPhone.

The electronic device or tablet computer 100 includes a display and, in particular, a touch-sensitive display or touch sensitive LCD (liquid crystal display) which forms a scrolling arrangement of the device. Such scrolling arrangements are known in the art. With this type of touch-sensitive scrolling arrangement, a user scrolls through a document displayed on the screen by dragging their finger across the screen in the direction in which they wish to scroll the document.

Displayed on the display of the tablet computer 100, by way of example, as shown schematically in FIG. 2, is a long web page or document 102 of 7 paragraphs that has an application such as a YouTube (registered trade mark) video 104 embedded in the column of text 105 after the 4th paragraph 106. The text and activatable content are fixed relative to one another. In this example, the display of the device is in a portrait configuration. The embedded video is indicated by a still image from the video. When a user reads text they will typically drag (or in other electronic devices, such as a desktop or laptop computer slide or rotate a scroll wheel or scrolling arrangement) in incremental amounts down the page as they read (as indicated by arrow 108 in FIG. 2). The video is not playing (it is paused or still) when the user scrolls through the document. In this example, a user uses the scrolling arrangement by dragging their finger over the touch-sensitive surface of the display in the plane of the display, away from the user, the content (text and still video frame) of the display also moves in the plane of the display, away from the user (up the page in the example of FIG. 2). The content displayed on the display of the electronic device continues to move in the plane of the display even when the user stops dragging their finger; it has simulated momentum. Once a user stops scrolling or dragging their finger, the moving content slows or decelerates until it comes to stop after a predetermined time. The system or electronic device detects the proximity of the still video 104 or any application or activatable content to the vertical center 110 of the screen or display whenever the user stops scrolling. If the user scrolls the window to within predefined bounds or limits, above 112 and below 114 the application or video application, the system ‘magnetically’ scrolls or automatically scrolls the video element to the center of the display, grows the video to a majority of the full screen size or the full screen size and automatically begins playing the video; there is no additional user action such as a button being pressed in order for the video to play or the activatable content to be activated Once the user has finished watching the video, the user simply scrolls the window up (the same direction they were previously scrolling) which automatically pauses the video, shrinks the video back to its original size and scrolls the window up as normal.

This allows a user to consume multimedia or activatable content within a column of text by only using the scroll gesture or action. The user need not find and press any buttons to play, activate full screen mode, which disrupts the reading/consuming experience.

This example illustrates an embodiment of the invention in which a user scrolls text with embedded activatable content up and down, the invention is equally applicable to an arrangement whereby a user scrolls content from left to right, typically when the display of the device is in a landscape configuration. In this example, the activatable content 104 in the, for example, web page being displayed, takes up less than a majority of the electronic device display. In this case, the activatable content takes up less than half (50%) of the electronic device display. The rest of the display includes the text 105.

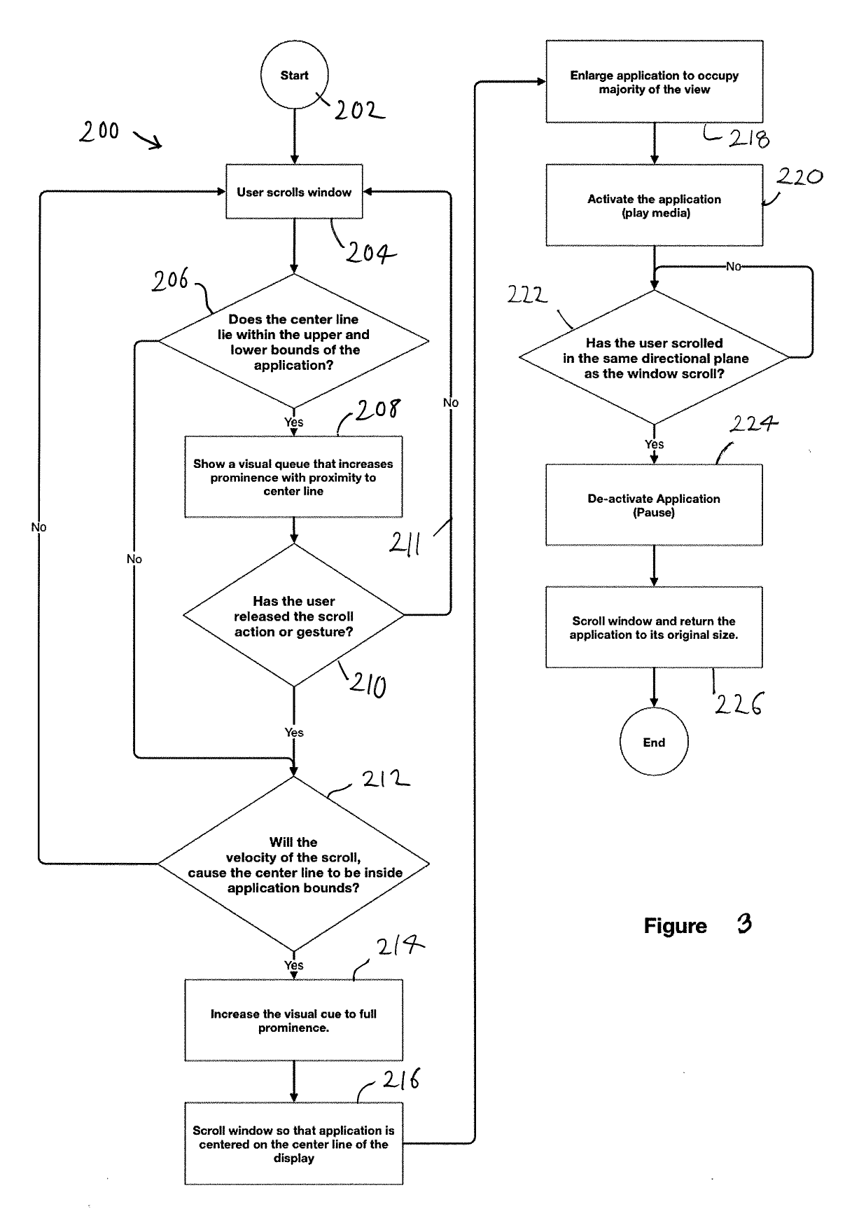

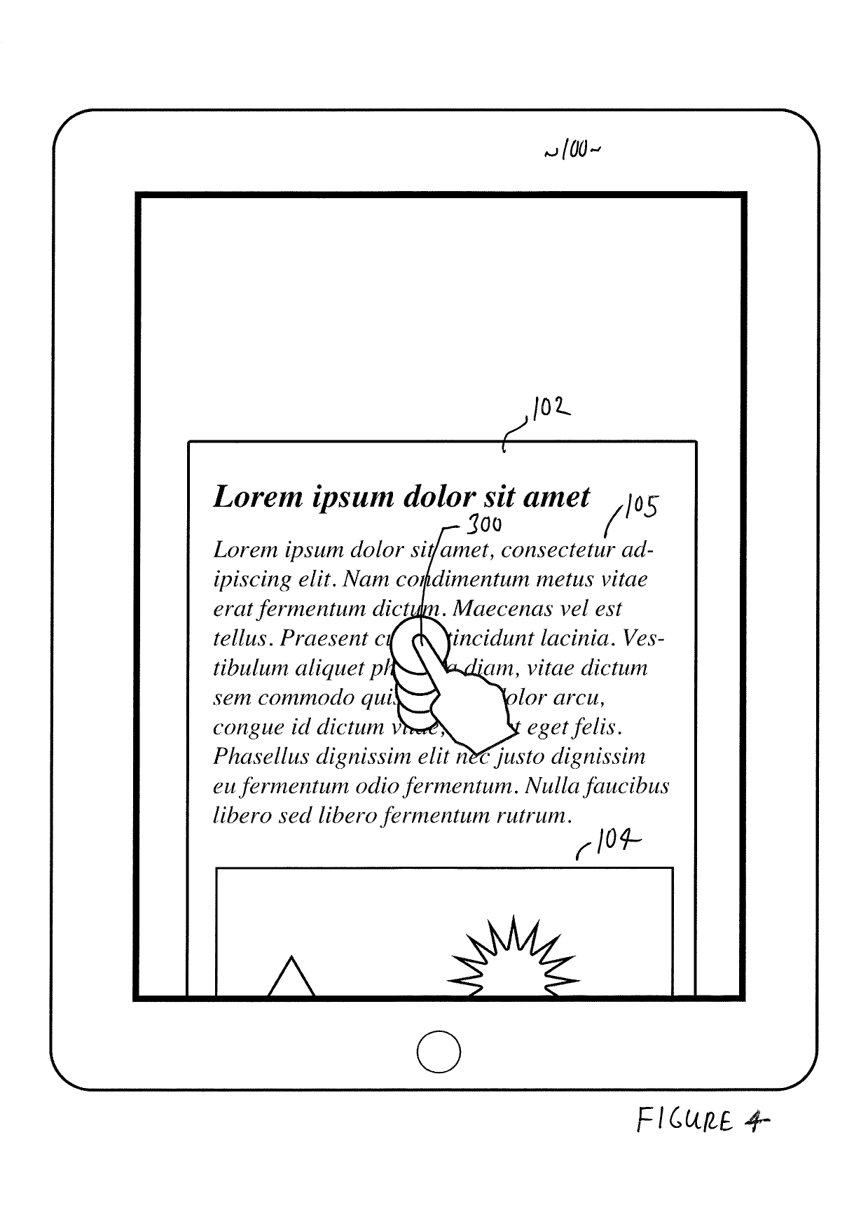

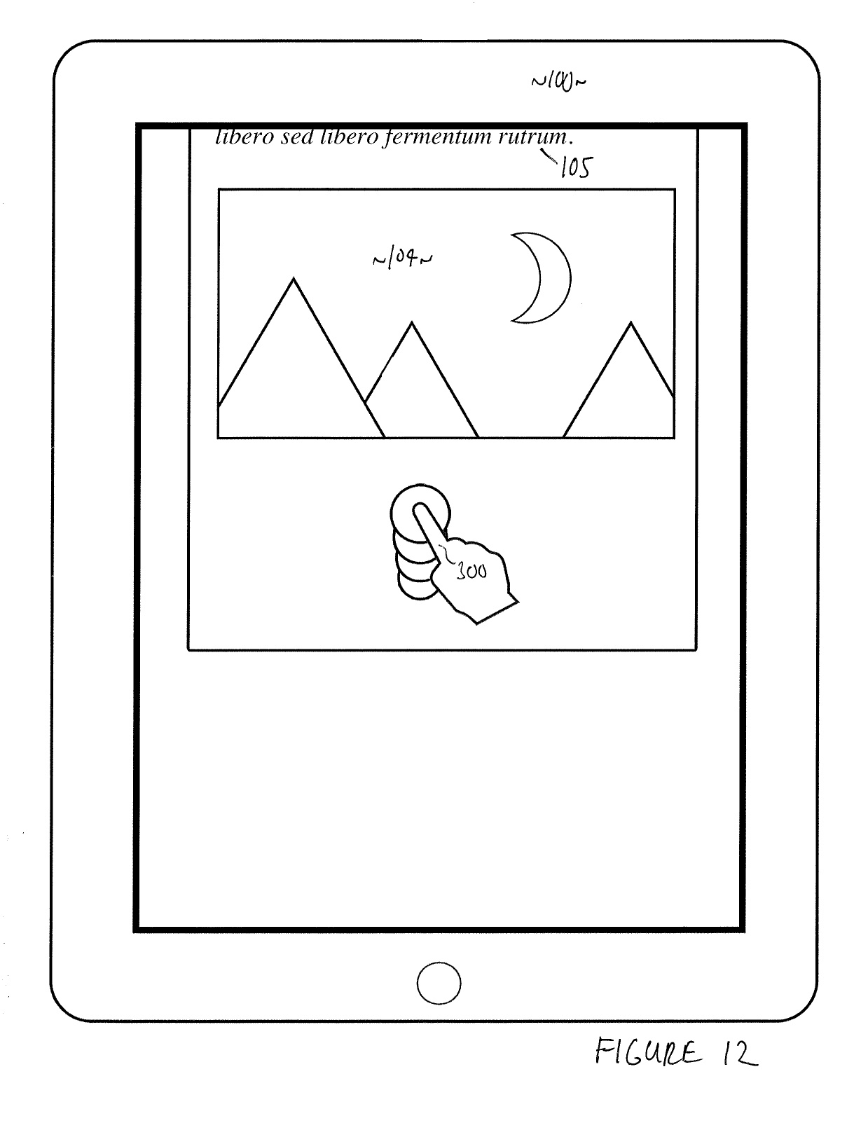

The flow diagram 200 of FIG. 3, with reference to FIGS. 4 to 12 which show the display of the device, explain the method implemented on the electronic device or tablet computer 100 and, in particular, an Apple iPad, iPad 2 or iPad 3 (the new iPad) in more detail. FIGS. 4 and 12 are similar in many respects and like features have been given like reference numerals.

Turning to FIG. 3, at the first step, start 202, the user opens a document, for example a webpage on a web browser and this is displayed in the display or in a window of the electronic device 100. As illustrated in FIG. 4, the document 102 includes a text portion 105 and activatable content, such a video 104, which are fixed relative to one another.

At the next step 204, the user, using a scrolling arrangement of the electronic device 100, in this case, as illustrated in FIG. 4, scrolling using a touch-sensitive LCD (liquid crystal display) screen of the electronic device by dragging a finger 300 over the surface of the display device, scrolls continuously through the document 102, which includes text 105 in which activatable content, such as a video 104 is embedded. At the next step, step 206, the electronic device assesses the position of the video in the display of the device to ascertain whether the center of the video (a virtual or theoretical line half way between the top and bottom of the image of a frame of the video that is not visible or displayed on the display) is within limits or between upper and lower bounds.

An indication is provided when the activatable content or image from the video 104 and, in particular the center of the video, is within the limits or between upper and lower bounds. The indication takes the form of a visual cue. In this example, the visual cue is an increase in size of the activatable content or, in other words, the still image of the video being displayed increases. The indication is greater the closer the activatable content is to a line centered between the limits or, in other words, as shown at step 208 the visual cue increases in prominence with proximity to the center line.

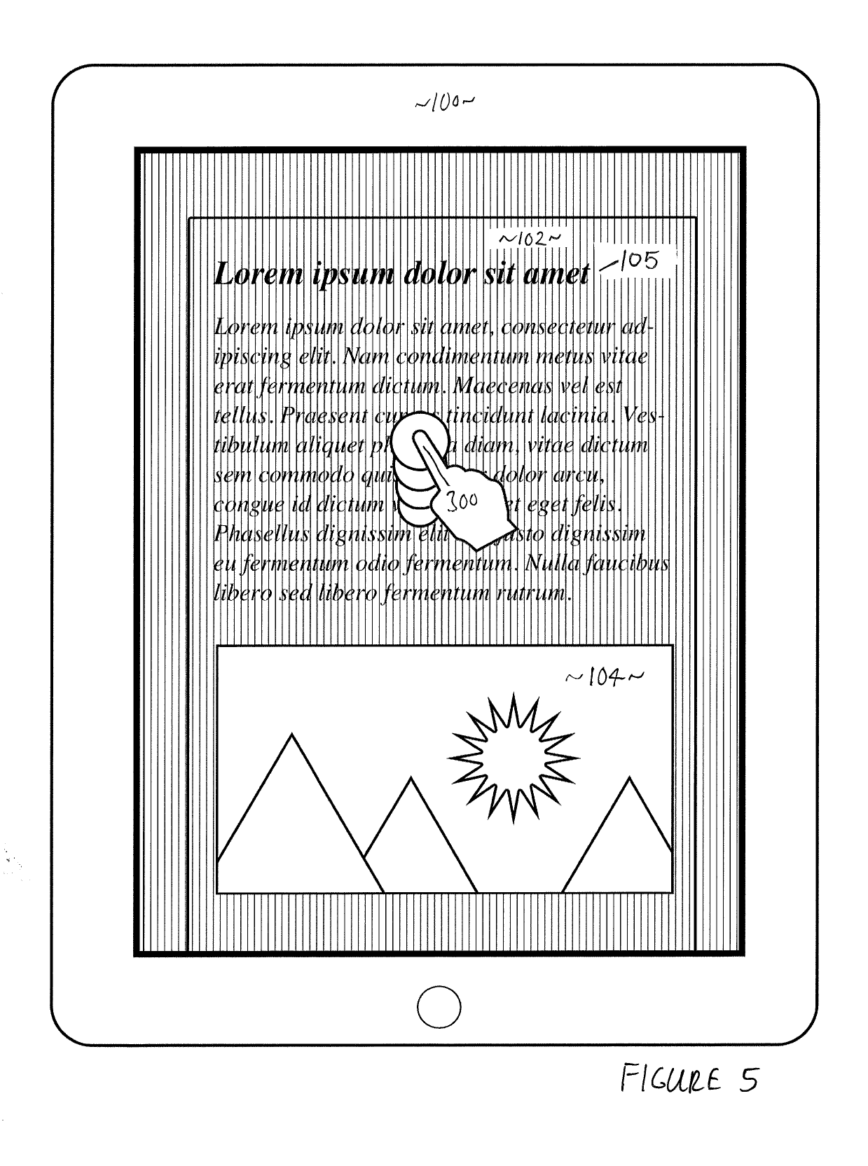

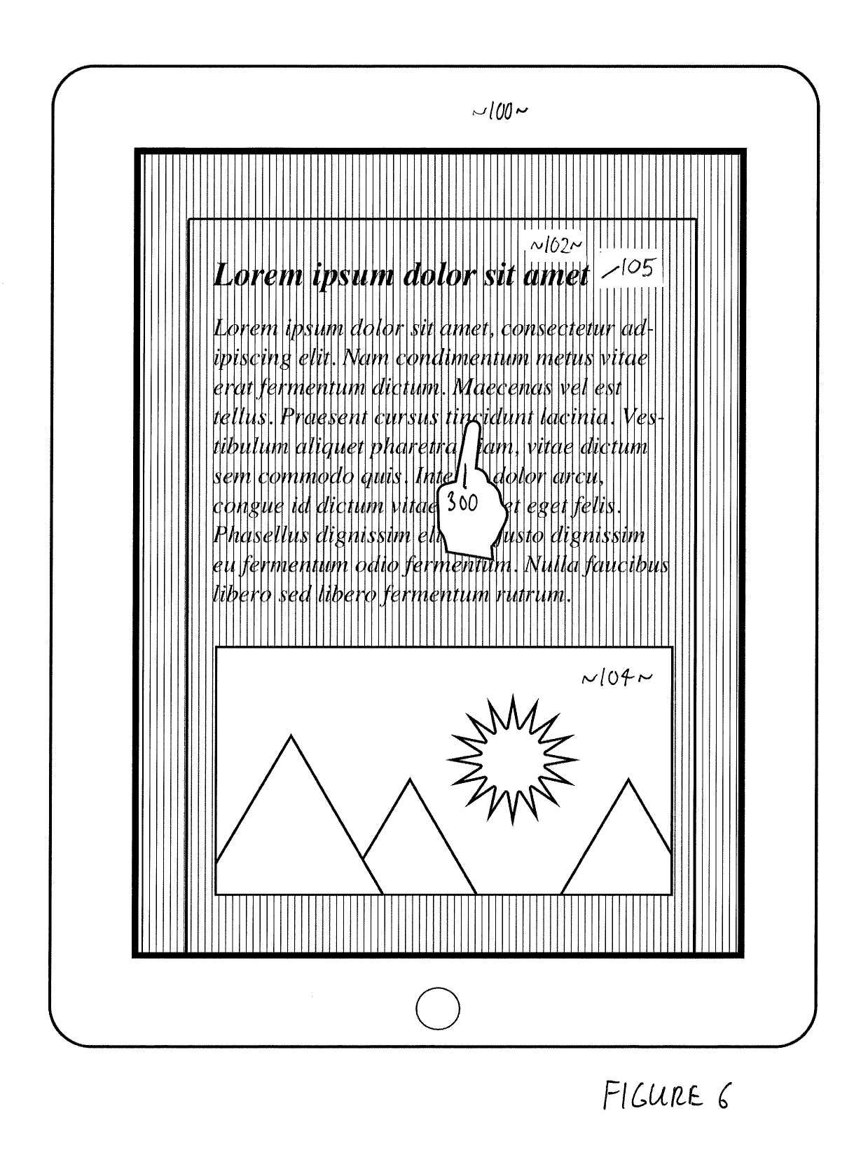

As illustrated at step 210 of FIG. 3, if the user continues to scroll through the document or webpage 102 without releasing the scroll action or gesture (the “No” path 211), the activatable content or video portion 104 moves away from the center line, and decreases in size or prominence back to its previous size. Steps 206 and 208 repeat as the user scrolls through the document or webpage. If, on the other hand, the user releases the scroll action or gesture, the scrolling document decelerates. As illustrated at step 212, if its scroll velocity, when the scroll action or gesture is stopped or released by the user, is such that a center line of the activatable content lies, at least in part, inside predetermined bounds or between limits, then the visual cue is increased to full prominence as illustrated by step 214 of FIG. 3. In this example, as illustrated in FIGS. 5 and 6 this includes a darkening of content except all activatable content, for example the text portion 105 to either side of the activatable content. The darkening may go so far that the non-activatable content (for example text) is not displayed or not visible on the display. In FIG. 5, the user is shown terminating or finishing a scrolling action or gesture by ending the dragging of their finger 300 over the surface of the display. In FIG. 6, the user has released or stopped the scroll gesture by stopping dragging their finger 300 over the surface of the display.

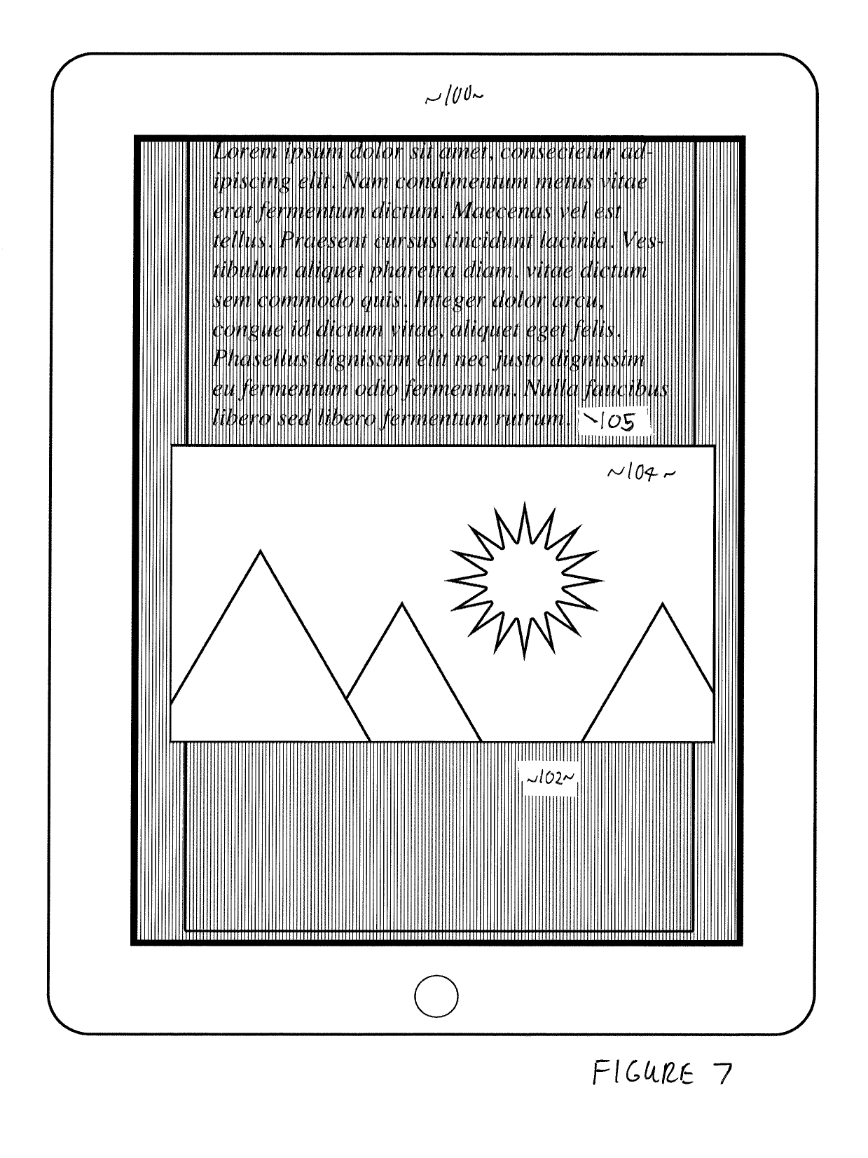

The activatable content is then automatically moved towards the center of the display as illustrated in FIG. 7 and centered on a line (not-visible) between the limits (step 216 of FIG. 3).

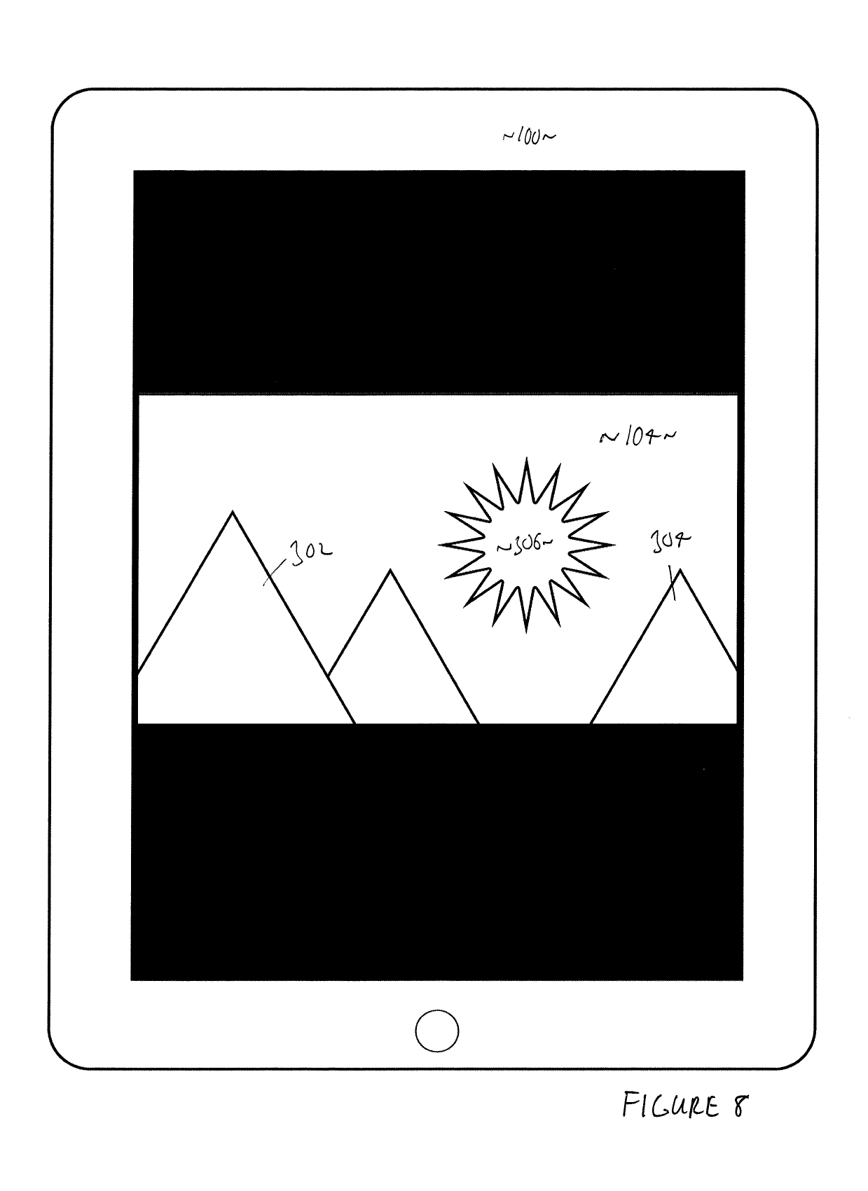

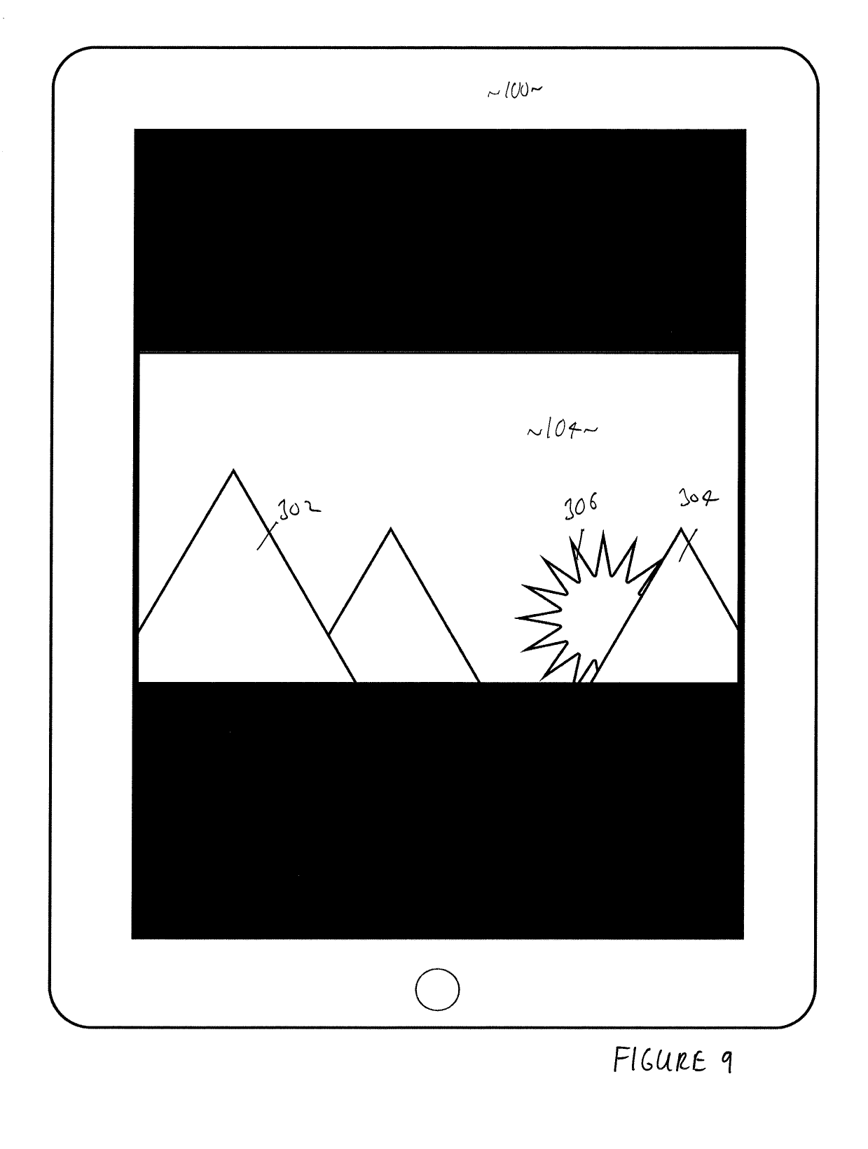

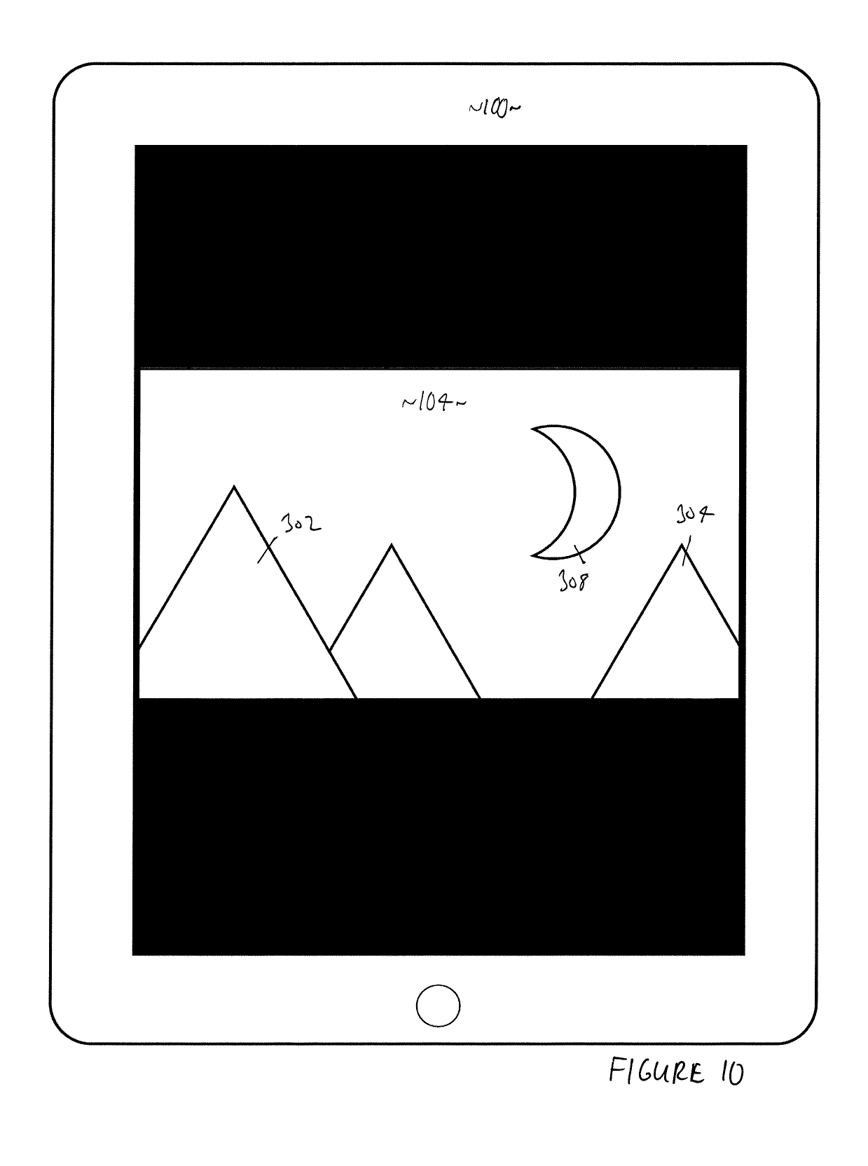

The activatable content 104 enlarges, for example, to occupy a majority of the area of the electronic device display (step 218 of FIG. 3) or at least a larger portion of the display (also illustrated in FIG. 7). The activatable content or application is activated, in this example, the video or media plays (step 220 of FIG. 3). Playing of the media or video is illustrated in FIGS. 8 to 10. It is a video of a setting sun and a rising moon. In FIG. 8, the video is about to play and so the same image or frame of the video is displayed as that that was originally in the document or webpage (three pyramids: two in a group 302 and one alone 304, and the sun 306 between the group and the lone pyramid). FIG. 9 illustrates the video after it has played or been activated for a short time. The sun has started to set and has moved down and partially behind the lone pyramid. FIG. 10 illustrates the video after it has played or been activated longer. The sun has set (and is no longer visible) and the moon 308 has risen between the group and the lone pyramid. Importantly, while the video is playing the area around the video (above and below) is blank and dark (text is not visible).

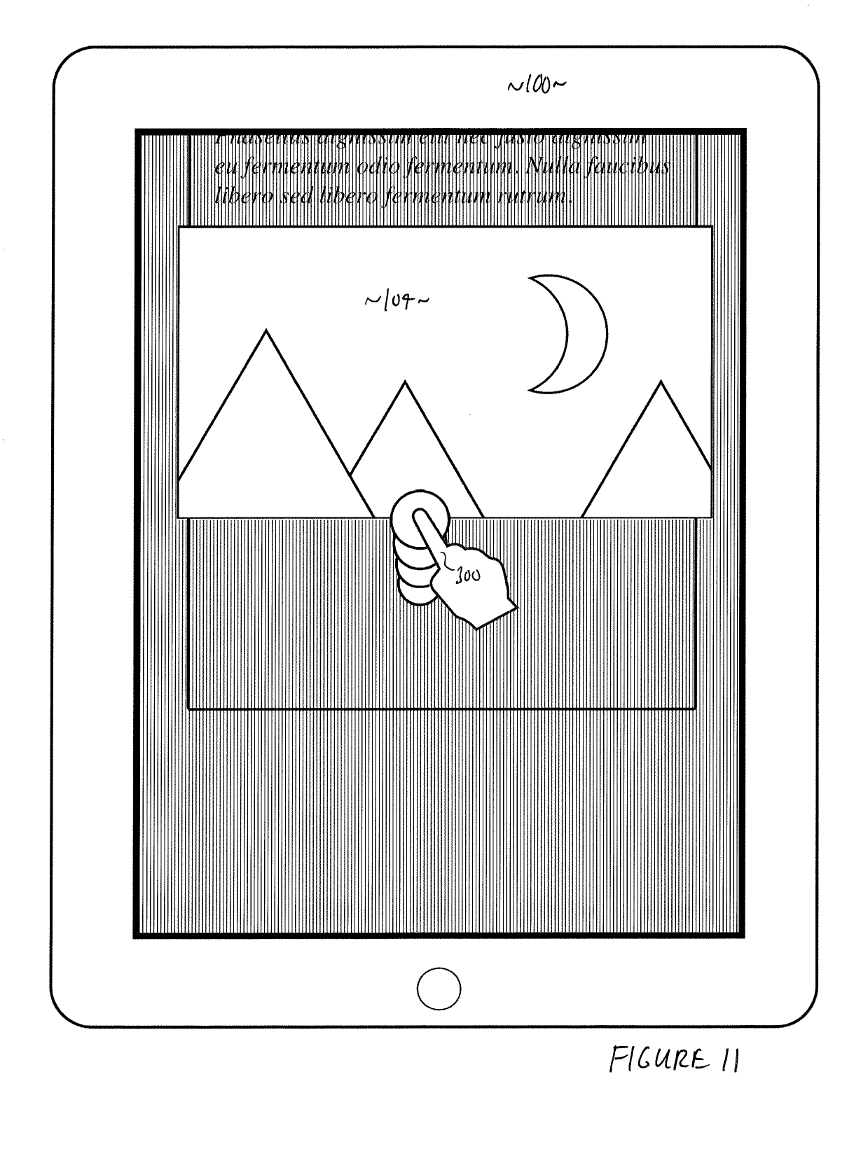

While the activatable content 104 is activated or playing, if the user actuating the scrolling arrangement or applies a scrolling action or gesture as had previously caused the content of the page (text and activatable content) to scroll (step 222 of FIG. 3), the activation of the content is stopped (the video, for example, stops playing) as illustrated at step 224 of FIG. 3 and in FIG. 11. The activatable content reduces in size. As illustrated at step 226 of FIG. 3, it returns to the same size or original size such as at step 204 of FIG. 3 when the content was originally being scrolled through. The activatable content or application remains in the state it was when stopped or paused. For example, if the activatable content is a video then, when it is stopped, the still image of the video that is displayed is the image displayed when the video was stopped. If the activatable content is a game for example, then, when it is stopped, the still image of the game that is displayed is the image displayed when the game was stopped. Furthermore, there is no longer darkening of content except all the activatable content (for example, of the text portion 105 to other side of the activatable content) as illustrated in FIG. 12. Text around and, in particular, above and below the activatable content, is visible. In this example, the content of the window (text and activatable content) scrolls in the direction of the scrolling action. In this example, in the same plane direction (but it may be in a different direction in the plane) or axis as the content was being scrolled through before the video played. For example, the downward direction of the electronic device display (typically towards the user).

The method may be implemented in software. The software may be stored on a computer readable medium, such as hard drive or solid state memory. The software may be downloadable from the Internet.

Embodiments of the present invention have been described. It will be appreciated that variations and modifications may be made to the described embodiments within the scope of the present invention.

1. A method of activating activatable content on an electronic device display, the method comprising the steps of:
i) a user actuating a scrolling arrangement of an electronic device to scroll substantially continuously through content including activatable content displayed on the electronic device display;
ii) the user stopping actuating the scrolling arrangement; and
iii) without user actuation of the electronic device, the electronic device activating the activatable content if the activatable content stops scrolling between two spaced apart limits of the electronic device display.

2. A method according to claim 1, wherein step i) further comprises the step of providing an indication of the activatable content when it is between the limits.

3. A method according to claim 2, wherein the indication comprises a visual cue.

4. A method according to claim 3, wherein the visual cue comprises an increase in size of the activatable content.

5. A method according to claim 2, wherein the indication is greater the closer the activatable content is to a line centered between the limits.

6. A method according to claim 1, wherein step iii) further comprises the step of providing an indication of the activatable content when it is between the limits.

7. A method according to claim 6, wherein the indication comprises a visual cue.

8. A method according to claim 7, wherein the visual cue comprises a darkening of content except all activatable content at least a part of which is between the limits.

9. A method according to claim 8, wherein the darkening comprises the content, except all activatable content at least a part of which is between the limits, not being displayed.

10. A method according to claim 6, wherein step iii) further comprises centering the activatable content on a line centered between the limits.

11. A method according to claim 1, wherein:
step i) comprises activatable content displayed in less than a majority of the electronic device display; and
step iii) further comprises the electronic device display displaying the activatable content in a majority of the electronic device display area.

12. A method according to claim 1, further comprising the step of:
iv) a user actuating a scrolling arrangement of an electronic device in the same direction or axis as step i) causing the activatable content to stop activating.

13. A method according to claim 11, further comprising the step of:
iv) a user actuating a scrolling arrangement of an electronic device in the same direction or axis as step i) causing the activatable content to stop activating; and
v) displaying the activatable content the same size as in step i).

14. A method according to claim 12, wherein the same direction comprises a downward direction of the electronic device display.

15. A method of displaying content on an electronic device display, the method comprising the steps of:
i) a user actuating a scrolling arrangement of an electronic device to scroll substantially continuously through content, including activatable content displayed in less than a majority of the electronic device display, displayed on the electronic device display;
ii) the user stopping actuating the scrolling arrangement; and
iii) the electronic device display displaying the activatable content in a majority of the electronic device display area if the activatable content stops scrolling between two spaced apart limits of the electronic device display.

16. A method according to claim 15, wherein step i) further comprises the step of providing an indication of the activatable content when it is between the limits.

17. A method according to claim 16, wherein the indication comprises a visual cue.

18. A method according to claim 17, wherein the visual cue comprises an increase in size of the activatable content.

19. A method according to claim 16, wherein the indication is greater the closer the activatable content is to a line centered between the limits.

20. A method according to claim 15, wherein step iii) further comprises the step of providing an indication of the activatable content when it is between the limits.

21. A method according to claim 20, wherein the indication comprises a visual cue.

22. A method according to claim 21, wherein the visual cue comprises a darkening of content except all activatable content at least a part of which is between the limits.

23. A method according to claim 22, wherein the darkening comprises the content, except all activatable content at least a part of which is between the limits, not being displayed.

24. A method according to claim 15, wherein step iii) further comprises centering the activatable content on a line centered between the limits.

25. A method according to claim 15, further comprising the step of:
iv) a user actuating a scrolling arrangement of an electronic device in the same direction or axis as step i) causing the activatable content to stop activating.

26. A method according to claim 25, further comprising the step of:
iv) a user actuating a scrolling arrangement of an electronic device in the same direction or axis as step i) causing the activatable content to stop activating; and
v) displaying the activatable content the same size as in step i).

27. A method according to claim 26, wherein the same direction comprises a downward direction of the electronic device display.

28. An electronic device comprising:
an electronic device display; and
a scrolling arrangement;
the electronic device being configured to activate activatable content on the electronic device display by:
i) a user actuating the scrolling arrangement of the electronic device to scroll substantially continuously through content including activatable content displayed on the electronic device display;
ii) the user stopping actuating the scrolling arrangement; and
iii) without user actuation of the electronic device, the electronic device activating the activatable content if the activatable content stops scrolling between two spaced apart limits of the electronic device display.

29-41. (canceled)

42. An electronic device comprising:
an electronic device display; and
a scrolling arrangement;
the electronic device being configured to display content on the electronic device display by:
i) a user actuating the scrolling arrangement of the electronic device to scroll substantially continuously through content, including activatable content displayed in less than a majority of the electronic device display, displayed on the electronic device display;
ii) the user stopping actuating the scrolling arrangement; and
iii) the electronic device display displaying the activatable content in a majority of the electronic device display area if the activatable content stops scrolling between two spaced apart limits of the electronic device display.

43-54. (canceled)
